(19) United States
(12) Patent Application Publication
(10) Pub. No.: US 2002/0113884 A1
(43) Pub. Date: Aug. 22, 2002

(54) Digital photographing apparatus, photographing apparatus, image processing apparatus and recording medium

(75) Inventors: Junichi Tanii, Osaka (JP); Minoru Kuwana, Osaka (JP)

Correspondence Address: MCDERMOTT, WILL & EMERY, 600 13th Street, N.W., WASHINGTON, DC, 20005-3096, US

(73) Assignee: Minolta Co., Ltd.

(21) Appl. No.: 10/075,225

(22) Filed: Feb. 15, 2002

(30) Foreign Application Priority Data
Feb. 16, 2001 (JP) 2001-40242

(51) Int. Cl. H04N 5/217; H04N 5/222; G03B 13/00

(52) U.S. Cl. 348/241; 348/333.04; 348/375; 348/348; 348/211.9; 382/289

(57) ABSTRACT

A warp corrector 201, which corrects warp in which the perspective is exaggerated when an image is captured with the user's face at close range, is included in a cellular phone 1 having an imaging portion 2. The warp corrector 201 performs processing to enlarge the peripheral areas of the image relative to the center, and generates corrected image data 232. As a result, a natural image of the user's face can be displayed on the display 11 of the cellular phone or sent.

This application is based on application No. 2001-40242 filed in Japan, the content of which is hereby incorporated by reference.

### BACKGROUND OF THE INVENTION

1. Field of the Invention

This invention relates to a technology to correct warp of a captured image.

2. Description of the Related Art

Technologies to correct via image processing image warp that occurs due to lens aberration and image warp observed using a fish-eye lens, i.e., “distortion”, are conventionally known. For example, a technology is known that corrects image warp based on interpolation while changing the order of reading of the pixel signals from the solid state image sensing device in accordance with the geometric warp occurring due to the lens.

If the image of the face of a person or the like is captured from a point that is relatively nearby, an image is obtained in which the perspective appears exaggerated. Because a straight line is captured as essentially a straight line when the image of a two-dimensional object is captured from a point that is similarly nearby, it can be appreciated that this type of warp or distortion is different in nature from so called “distortion” which is a kind of lens aberrations. When a camera comes close to a three-dimensional object that has depth, the peripheral areas of the object, which are farther away from the camera than the front area, appear to be closer to the front area than they really are, resulting in a warp that causes the image to appear as if the perspective were exaggerated (the type of warp in which the perspective becomes exaggerated, as in this case, will hereinafter be termed ‘exaggeration warp’, as distinguished from distortion). Because exaggeration warp differs from distortion, a new technique to correct such warp is required.

In particular, cellular phones in which a digital camera is mounted are already on the market, and it is foreseen that in the future cellular phones will be used as TV phones by which to capture the image of the user's face while he is talking through the phone. With a cellular phone containing a camera, the lens is adjusted to have a wide-angle focal length such that the face of the user captured in the image is appropriately sized. When the user's face is close to the camera when such an optical system is used, the exaggeration warp becomes more noticeable.

### SUMMARY OF THE INVENTION

An object of the present invention is to correct warp in which the perspective of a three-dimensional object is exaggerated.

In order to attain this object, a first aspect of the present invention comprises a digital photographing apparatus including an image sensor that obtains the image of the object, as well as a corrector that corrects the image warp that occurs due to the three-dimensional configuration of the main object and the close proximity between the main object and the image sensor.

Furthermore, it is preferred that the need for correction be determined based on the size of the main object in the image, the distance from the image sensor to the main object, or the like.

Another aspect of the present invention comprises an photographing apparatus including an image sensor that obtains the image of the object, a correction lens that corrects the image warp that occurs due to the three-dimensional configuration of the main object and the close proximity between the main object and the image sensor, and structure that advances or retracts the correction lens toward or away from the optical axis of the image sensor.

Still another aspect of the present invention comprises a program that causes a computer to execute a routine, the program including a step of preparing image data and a step of correcting via processing of the image data and during the capturing of the image the image warp that occurs due to the three-dimensional configuration of the main object and the close proximity between the main object and the image sensor.

Still another aspect of the present invention comprises an image processing apparatus that includes (i) a memory that stores image data, and (ii) a corrector that corrects via processing of the image data and during the capturing of the image the image warp that occurs due to the three-dimensional configuration of the main object and the close proximity between the main object and the image sensor.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a drawing showing an external view of a cellular phone which is a first embodiment of the present invention;

FIG. 2 is a block diagram showing the construction of the cellular phone and the construction of the imaging portion therein;

FIG. 3A is a drawing showing the manner in which imaging is performed whereby warp causing the perspective to become exaggerated does not occur;

FIG. 3B is a drawing showing an image that is not warped;

FIG. 4A is a drawing showing the manner in which imaging is performed whereby warp causing the perspective to become exaggerated occurs;

FIG. 4B is a drawing showing a warped image;

FIG. 5 is a drawing showing the relationship between a point on the main object and the lens;

FIG. 6 is a block diagram showing a construction to correct the image warp in the first embodiment;

FIG. 7 is a drawing showing the sequence of operations performed during the routine carried out by the cellular phone when an image is obtained;

FIG. 8 is a drawing showing the change in enlargement rate in accordance with the distance from the center of the image;

FIG. 9 is a drawing showing a corrected image displayed on the display;

FIG. 10 is a drawing showing the cellular phone being used to capture the image of the user's face;

FIG. 11 shows a second embodiment of the present invention and comprises a drawing showing sections that are created based on the distance from the center of the image;

FIG. 12 is a drawing showing the change in enlargement rate per section;

FIG. 13 shows a third embodiment of the present invention and comprises a drawing showing sections used to determine the size of the main object;

FIG. 14 is a drawing showing the change in enlargement rate in accordance with the distance from the center of the image;

FIG. 15 is a drawing showing the change in enlargement rate in accordance with the distance from the center of the image;

FIG. 16 is a block diagram showing the construction to correct the image warp;

FIG. 17 is a drawing showing the sequence of operations carried out by the cellular phone when an image is obtained;

FIG. 18 is a drawing showing the sequence of operations carried out by the cellular phone when an image is obtained;

FIG. 19 shows a fourth embodiment of the present invention and comprises a block diagram showing the construction to correct the image warp;

FIG. 20 is a drawing showing the sequence of operations carried out by the cellular phone when an image is obtained;

FIG. 21 is a drawing showing the cellular phone and the main object;

FIG. 22 shows a fifth embodiment of the present invention and is a drawing showing the construction of an image processing apparatus; and

FIG. 23 shows a sixth embodiment of the present invention and comprises a drawing showing the construction of an imaging portion that has a correction lens.

### DETAILED DESCRIPTION OF THE PREFERRED EMBODIMENTS

<First Embodiment>

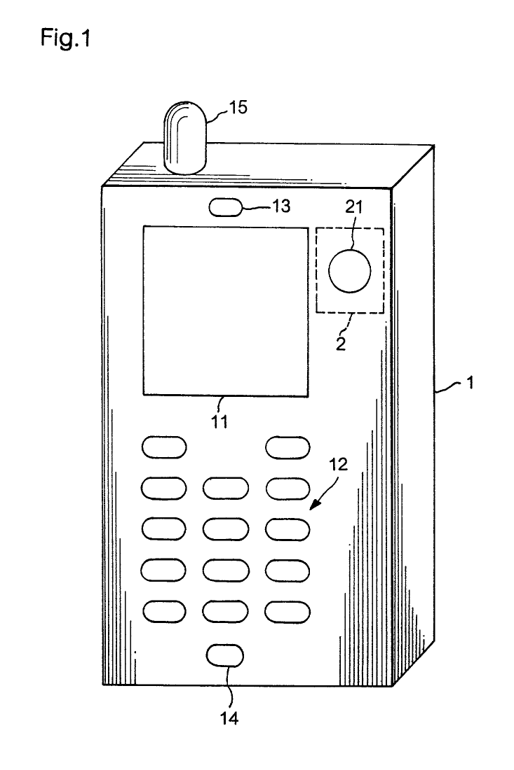

FIG. 1 shows an external view of a cellular phone 1 that is a first embodiment. The cellular phone 1 functions not only as a communication device by which to conduct voice communication and data communication, but also as an imaging device by which to obtain images.

The cellular phone 1 has an imaging portion 2 that captures images, as well as a liquid crystal display 11 that displays user menus and captured images on the front surface of the main body. Above the display 11 is located a speaker 13 that outputs sound during voice communication. To one side of the display 11 is the optical unit 21 of the imaging portion 2, and below the display 11 are located operation buttons 12 that receive commands from the user during voice communication, image capture, etc. as well as a microphone 14 that collects sound during voice communication. Furthermore, an antenna 15 for the transmission and receipt of information is located on the top surface of the main body.

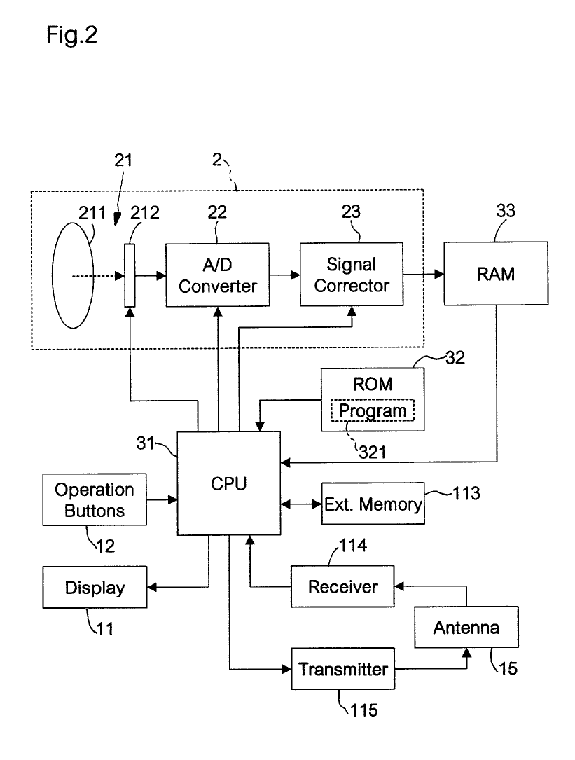

FIG. 2 is a block diagram showing the construction of the imaging portion 2 and the various components of the main body. Among the components shown in FIG. 2, the optical unit 21 that has a lens unit 211 and a CCD 212, the A/D (analog to digital) converter 22 and the signal corrector 23 are included in the imaging portion 2. The main body contains a CPU 31 that executes various types of arithmetic processing, a ROM 32 that stores the operation program, and a RAM 33 that stores various data. The various components of the imaging portion 2, the ROM 32 and the RAM 33 are connected to the CPU 31. Also connected to the CPU 31 are the display 11, the operation buttons 12, an external memory 113 mounted to the cellular phone 1, and the receiver 114 and transmitter 115 that respectively receive and transmit signals via the antenna 15.

The cellular phone 1 obtains images by the imaging portion 2, the CPU 31, the ROM 32 and the RAM 33. In other words, the image of the object is formed on the CCD 212 by the lens unit 211, and when the button among the operation buttons 12 that receives the user command to start image capture is pressed, the image signals from the CCD 212 are converted into digital signals by the A/D converter 22. The digital image signals resulting from conversion by the A/D converter 22, further undergo processing by the signal corrector 23 such as white balance and gamma correction, and are stored as image data in the RAM 33. The control of these processes is performed by the CPU 31, which operates in accordance with the program 321 stored in the ROM 32.

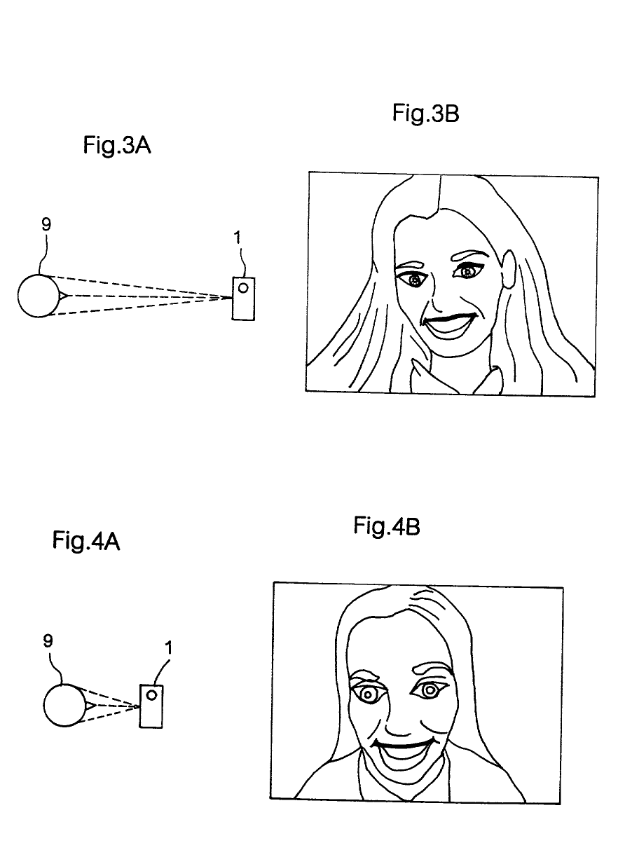

Various items of data can be sent and received between the RAM 33 and the external memory 113 via the CPU 31 based on input operations carried out via the operation buttons 12, and the display 11 displays various types of information as well as images stored in the RAM 33 or the external memory 113 based on control carried out by the CPU 31.

Where the main object 9 and the cellular phone 1 are located at a sufficient distance from each other when image capture is performed, as shown in FIG. 3A, a natural image can be obtained, as in the image shown in FIG. 3B. However, where the main object 9 and the cellular phone 1 are close together, as shown in FIG. 4A, an unnatural image results in which the perspective is exaggerated, as in the image shown in FIG. 4B.

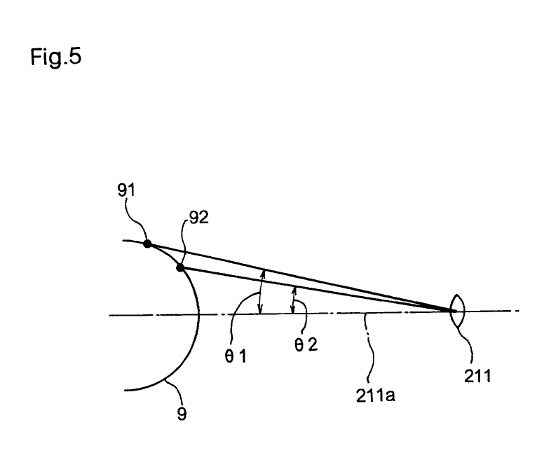

It is believed that this unnatural image is caused because, where the center area of the main object protrudes toward the imaging portion 2 relative to the peripheral areas, i.e., where the main object has an essentially convex configuration that protrudes toward the imaging portion 2, when the main object and the imaging portion 2 come closer to each other, the peripheral surfaces of the main object become increasingly parallel to the line that connects the imaging portion 2 and the peripheral areas. More specifically, as shown in FIG. 5, the unnaturalness is believed to be caused in the image because the difference between the angle θ1 formed between the light ray that strikes the lens unit 211 from a point 91 in a peripheral area of the main body 9 and the optical axis 211a of the lens unit 211, and the angle θ2 formed between the light ray that strikes the lens unit 211 from a point 92 located in front of the point 91 and the optical axis 211a, decreases as the lens unit 211 comes closer to the main object 9. In the following description, this unnaturalness of image will be referred as “warp” or “distortion”.

In addition, because the warp or distortion increases as the angle θ1 shown in FIG. 5 increases, where the main object is close to the imaging portion 2 and the image of the main object occupies a large percentage of the entire image, the exaggeration warp of the image becomes substantial.

Therefore, such warp is corrected in the cellular phone 1 via image processing carried out by the internal CPU 31.

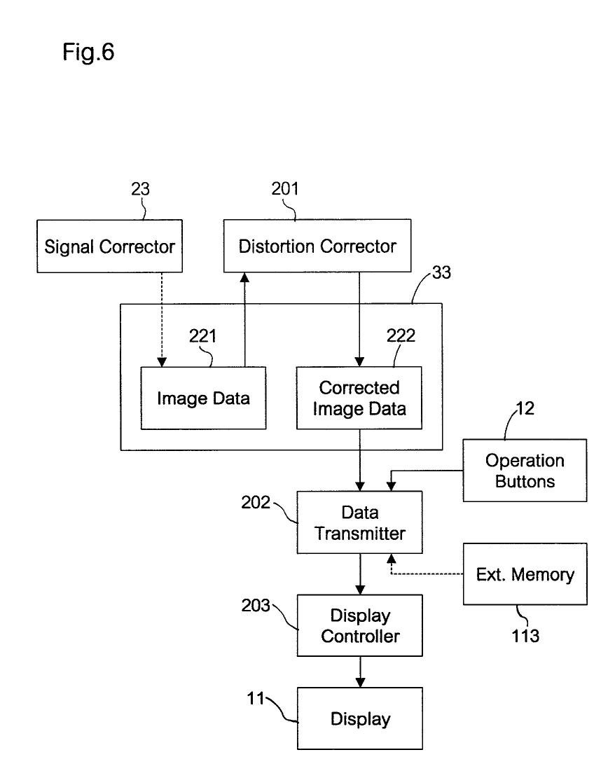

FIG. 6 is a drawing showing the construction of the functions that are realized by the CPU 31 when it operates in accordance with the program 321 stored in the ROM 32, as well as other components. Among the components shown in FIG. 6, the warp corrector 201, the data forwarder 202 and the display controller 203 are the functions realized by the CPU 31.

The warp corrector (distortion corrector) 201 performs warp correction, which is described below, with regard to the image data 221 output from the signal corrector 23 and stored in the RAM 33, and generates corrected image data 222. The data forwarder (data transmitter) 202 receives commands from the user via the operation buttons 12, obtains from the RAM 33 or the external memory 113 the display image data that includes the corrected image data 222, and supplies it to the display controller 203. The display controller 203 performs necessary processing with regard to the corrected image data 222 forwarded from the data forwarder 202, and causes the image to be displayed on the display 11.

In the cellular phone 1, it may be selected via the operation buttons 12 whether or not correction should be performed by the warp corrector 201.

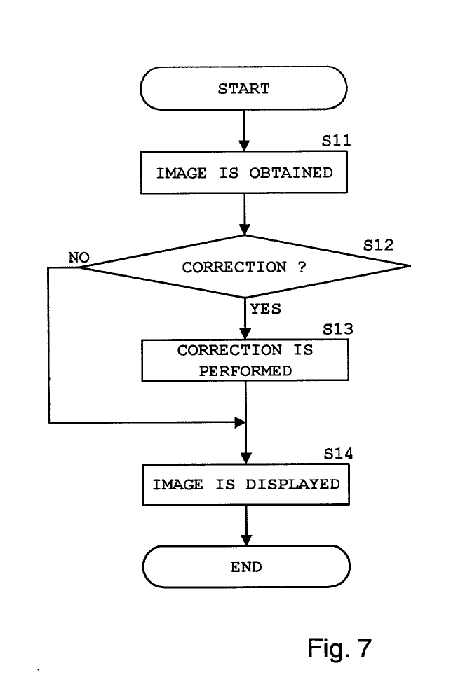

FIG. 7 is a drawing showing the sequence of operations carried out by the cellular phone 1 when it obtains an image. The operations of the cellular phone 1 are described below with reference to FIGS. 6 and 7.

First, an image is obtained by the imaging portion 2 based on the operation of the operation buttons 12, and is stored in the RAM 33 as image data 221 (step S11). It is verified here whether or not correction by the warp corrector 201 is selected, and if correction is to be performed, the warp corrector 201 performs processing to correct the image data 221 (steps S12 and S13).

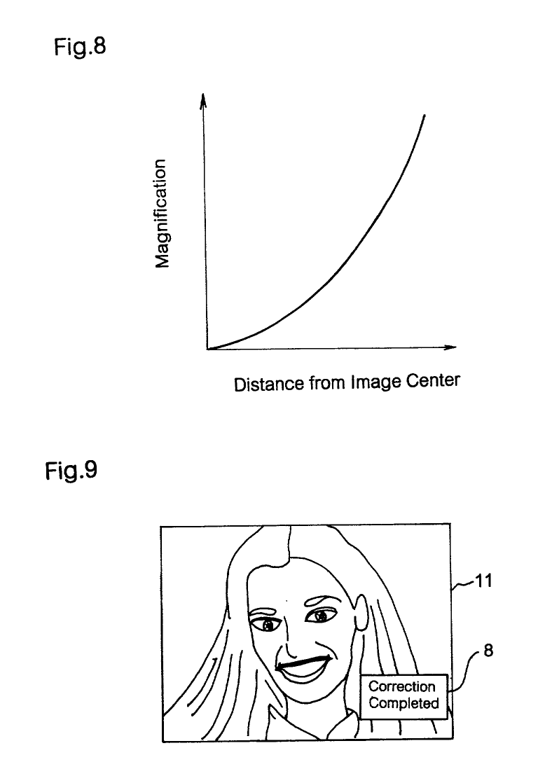

As described with reference to FIG. 5, the image warp that is caused by the close proximity of the main object to the imaging portion 2 comprises a warp in which the peripheral areas of the main object appear reduced in size relative to the center area. Therefore, the warp corrector 201 carries out correction that will enlarge the peripheral areas of the image relative to the center area. FIG. 8 is a drawing showing the relationship between the distance from the center of the image and the enlargement rate or magnification used during warp correction. As shown in FIG. 8, the farther a part is located from the image center, the larger the enlargement rate used to perform the enlargement becomes. Furthermore, the amount by which the enlargement rate increases also increases as the distance from the image center increases. Through such processing, where the image data 221 comprises the image data shown as an example in FIG. 4B, the corrected image data 222 becomes closer to the image data shown in FIG. 4A.

The display controller 203 then obtains the corrected image data 222 thus generated in the RAM 33 via the data forwarder 202, and the post-correction image is displayed on the display 11 (step S14).

FIG. 9 is a drawing showing an example of the display of a corrected image on the display 11. As shown in FIG. 9, when a corrected image is displayed, the display controller 203 displays in synthesis with the corrected image a phrase 8 that indicates that correction was performed by the warp corrector 201. Consequently, the user can easily recognize whether or not warp correction was performed, and is prevented from forgetting to initiate correction.

Where the setting is such that correction is not to be performed by the warp corrector 201, the data forwarder 202 forwards the image data 221 to the display controller 203 without any correction, and the image is displayed (steps S12 and S14).

Furthermore, the image data 221 or the corrected image data 222 is forwarded by the data forwarder 202 to the transmitter 115 shown in FIG. 2, and is then sent to another terminal via the antenna 15 or stored in the external memory 113, where necessary.

As described above, with regard to the cellular phone 1, when the image of the main object, particularly the image of the face of the user who is holding the cellular phone 1, is captured, the exaggeration warp may be corrected, allowing an image close to a natural image to be obtained. In addition, the setting as to whether or not correction should be performed may be switched, such that when the warp corrector 201 is disabled, the image of scenes at a distance, such as landscape, can be appropriately captured.

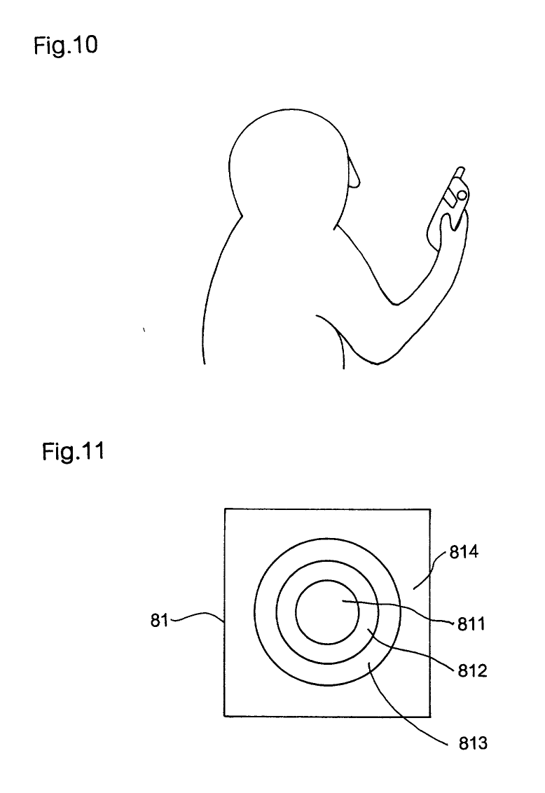

Moreover, in this embodiment, correction having the characteristic shown in FIG. 8 is uniformly performed with regard to the obtained image when performance of correction is selected. During normal image capture, the image warp is not constant due to differences in the shape of the main object and the object distance. However, where the imaging portion 2 is located on the front surface of the main body, as in the cellular phone 1, it is assumed that close-range image capture is performed only when the user wants to capture the image of her or his own face, as shown in FIG. 10, and send it to the other party to the communication. Furthermore, because the image is an image of a person's face, the need for correction is large. Where the image of a main object captured at close range is limited to a person's face, the three-dimensional configuration of the main object (the contours), the distance between the imaging portion 2 and the main object when image capture is performed by the cellular phone 1 while it is held in the user's hand, and the size of the image of the main object, are essentially constant.

Therefore, based on the assumption that correction is necessary only when the main object comprises the user's face, the cellular phone 1 includes only a simple correction function. Where the object of image capture is limited to the user's face, the design of the cellular phone 1 may be such that correction is performed at all times during image capture.

<Second Embodiment>

In the first embodiment, correction is performed in which the peripheral areas of the image are enlarged using an enlargement rate that is continuously increased from the image center, but the correction process may be further simplified.

FIG. 11 is a drawing showing an image 81 obtained by the imaging portion 2 and divided into multiple sections 811 through 814 in accordance with the distance from the image center. The warp corrector 201 performs correction, i.e., enlargement, using different enlargement rates for these sections 811 through 814. However, where there is a gap or overlapping between sections after correction, interpolation or partial elimination is performed where necessary.

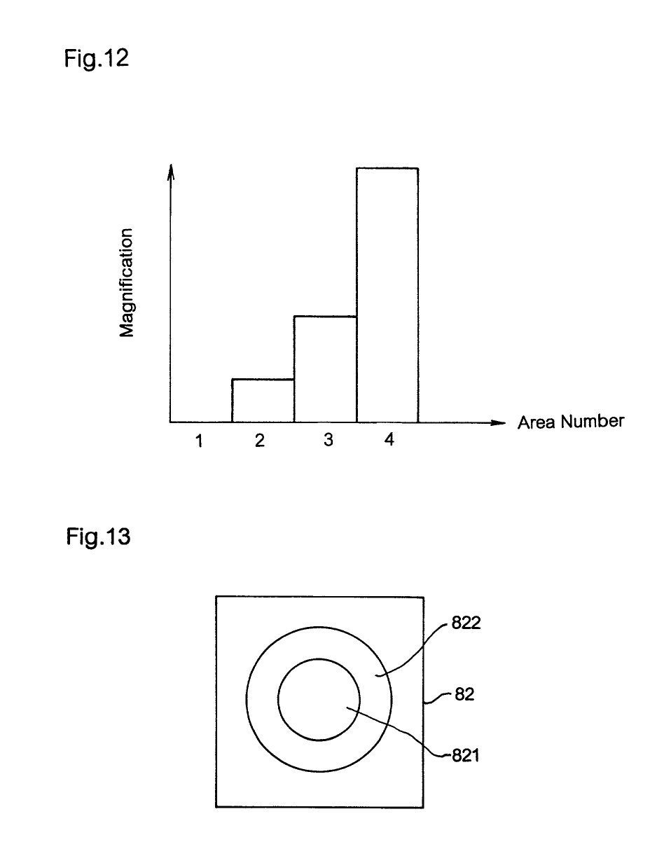

FIG. 12 is a drawing showing the enlargement rate used during enlargement for each section. The section numbers 1 through 4 correspond to the sections 811 through 814, respectively. As shown in FIG. 12, the farther away from the image center the section is, the larger the enlargement rate is set to be. Using these rates, the peripheral areas of the image are enlarged relative to the center of the image. Where such correction is carried out by the warp corrector 201, the processing by the warp corrector 201 is simplified, enabling correction to be performed quickly.

Where the main object is limited to the user's face, the image of the user's face has a more or less oval shape. Therefore, the borders between the sections 811 through 814 shown in FIG. 11 may similarly have an oval shape. Furthermore, the image may be divided into multiple rectangular sections aligned horizontally and vertically and an enlargement rate may be set for each section depending on the location of the section. The image may be divided into any multiple sections in this way, and by enlarging the sections using an enlargement rate appropriate for each section, more appropriate warp correction may be realized.

The shape of the sections may be changed depending on the configuration of the main object. For example, the shapes of the borders between the sections 811 through 814 may be determined in response to the contours of the main object by extracting the contours of the main object using image processing. Appropriate warp correction may be realized through such processing.

<Third Embodiment>

In the first and second embodiments, simple warp correction is performed based on a fixed correction characteristic, but correction may alternatively be carried out while the degree of correction is varied. A cellular phone 1 in which the degree of correction is varied depending on the size of the image of the main object relative to the overall image will be described below as the third embodiment. The construction of the cellular phone 1 is identical to that shown in FIGS. 1 and 2.

FIG. 13 is a drawing showing sections 821 and 822 that are set in the image 82 in order to detect the size of the image of the main object within the overall image. The section 822, however, includes the section 821. It is deemed in general that the exaggeration warp becomes more significant as the proportional size of the main object image relative to the overall image increases. In addition, because the main object can be deemed to be located in the center of the image at all times, by setting the sections 821 and 822 in the image 82 depending on the distance from the center of the image, and by changing the degree of correction based on the comparison of the size of the main object image with these sections 821 and 822, appropriate warp correction may be realized.

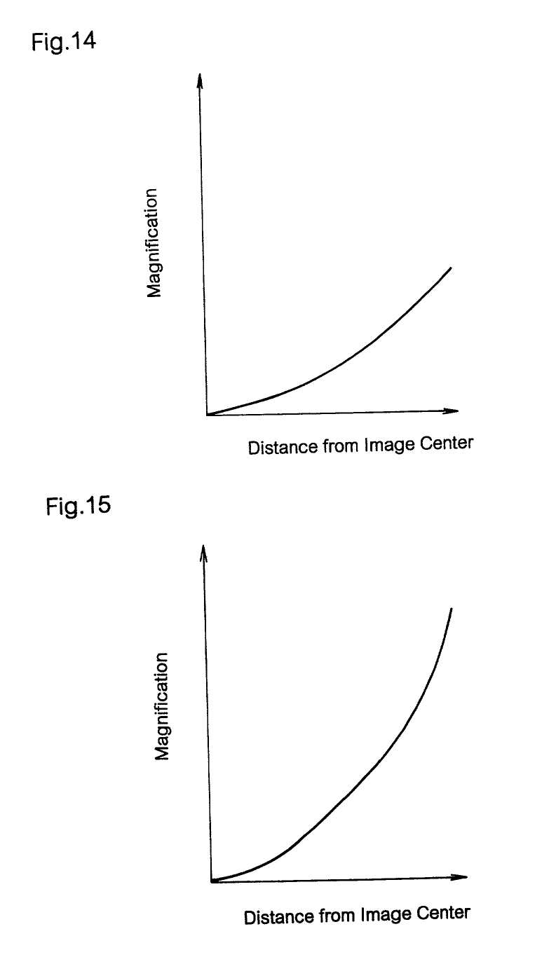

Specifically, where the main object image is contained within the section 821, it is determined that the warp in the peripheral areas of the main object image may be safely ignored and no correction is performed. Where the main object image is not contained in the section 821 but is contained in the section 822, it is presumed that the warp is somewhat conspicuous, and therefore a low degree of correction (i.e., the correction having the characteristic shown in FIG. 14) is performed, and where the main object image is not contained in the section 822, it is presumed that the warp is substantially conspicuous, and a high degree of correction (i.e., the correction having the characteristic shown in FIG. 15) is performed. In other words, the larger the main object image is, the stronger the degree of correction is set to be. In the explanation below, the degree of correction is referred to as the ‘correction level’, and the correction level at which no correction is performed is referred to as the level ‘0’, the correction level with the characteristic shown in FIG. 14 is referred to as the level ‘1’, and the correction level having the characteristic shown in FIG. 15 is referred to as the level ‘2’.

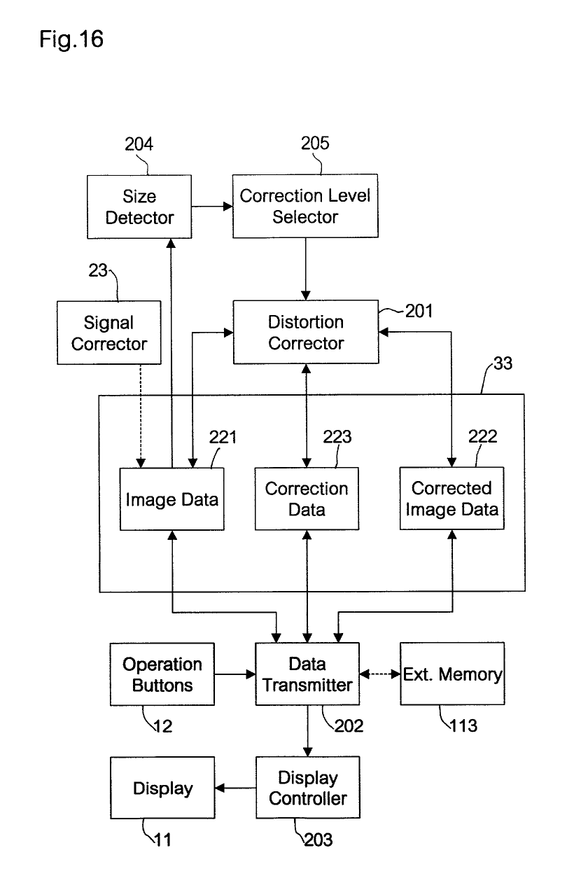

FIG. 16 is a drawing showing the construction of the functions that are realized by the CPU 31 in the third embodiment when it operates in accordance with the program 321 stored in the ROM 32, as well as other components. The construction shown in FIG. 16 is identical to that shown in FIG. 6, except that a size detector 204 that detects the size of the image of the main object and a correction level selector 205 that selects the correction level are added. Other components execute essentially the same processes or operations as in the first embodiment.

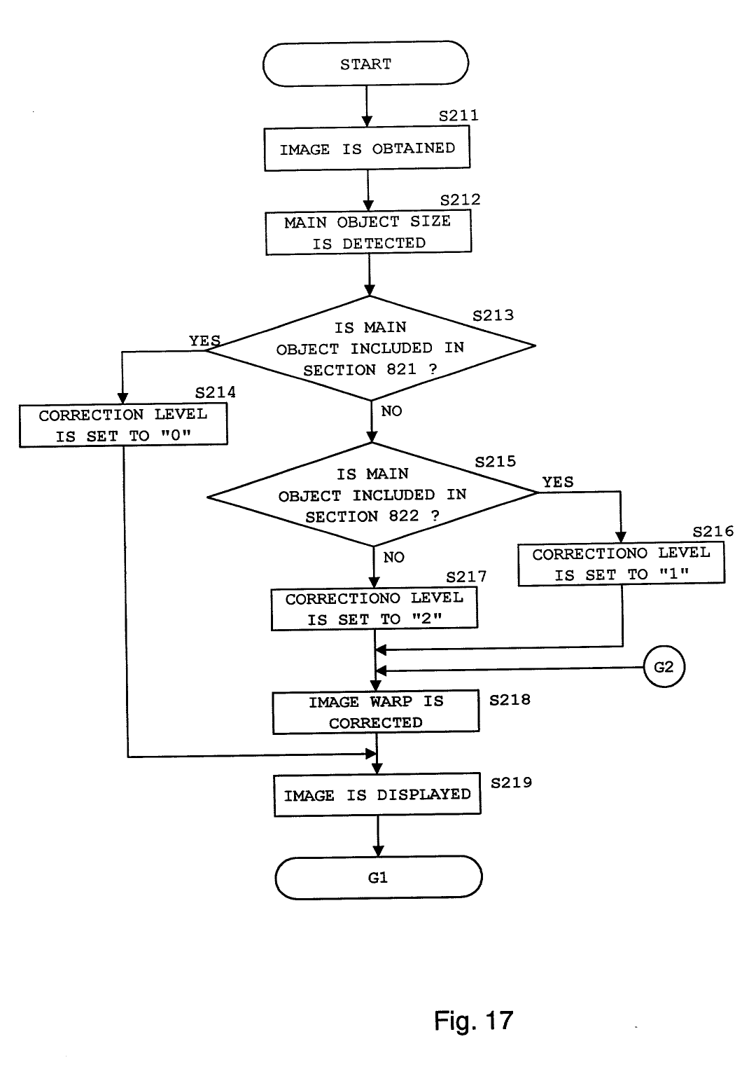

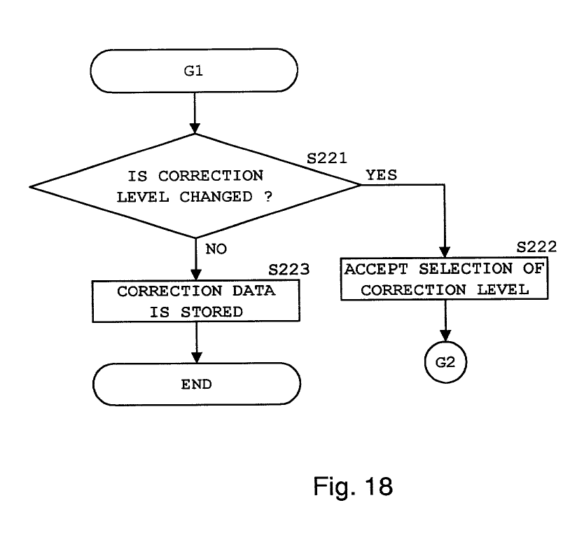

FIGS. 17 and 18 are drawings showing the sequence of operations performed by the cellular phone 1 of the third embodiment. The operations performed when the cellular phone 1 obtains an image are described below with reference to FIGS. 16 through 18.

First, when image capture is instructed via the operation buttons 12, image signals from the signal corrector 23 are stored in the RAM 33 as image data 221, and an image is obtained (step S211). The size detector 204 then detects the size of the image of the main object relative to the overall image (step S212). The size detector 204 (i) identifies the region of the image of the main object based on the location of clear edges in the image as well as on the color distribution in the image, and (ii) detects the size of the main object image by comparing the region occupied by the main object image with the sections 821 and 822 shown in FIG. 13.

The size of the main object image thus detected is input to the correction level selector 205, and where the main object image is included in the section 821, the correction level is set to ‘0’ (steps S213 and S214). Where the main object image extends beyond the section 821 but is contained in the section 822, the correction level is set to ‘1’ (steps S215 and S216). Where the main object image extends beyond the section 822, the correction level is set to ‘2’ (steps S215 and S217).

Subsequently, based on the correction level selected by the correction level selector 205, the warp corrector 201 corrects the warp of the image data 221 and generates corrected image data 222 (step S218). In other words, warp correction is not performed when the correction level is ‘0’, and where the correction level is ‘1’ or ‘2’, warp correction with a weak characteristic shown in FIG. 14 or with a strong characteristic shown in FIG. 15, respectively, is performed.

As described above, in the cellular phone 1, the need for correction is determined from the size of the main object image detected in essence via the section 821, and the correction level ‘1’ or ‘2’ is selected based on the size of the main object image by using the section 822.

When the corrected image data 222 is stored in the RAM 33, the data forwarder 202 forwards the corrected image data 222 to the display controller 203, whereupon the corrected image is displayed on the display 11 (step S219). When this is done, an indication of the correction level is synthesized into the display. Where the correction level is 0, the image data 221 is forwarded to the display controller 203, and the obtained image is displayed as is.

Here, the user views the displayed image and verifies that the correction is appropriate or that the preferred correction was made. If the correction is not desirable, a different correction level is selected via the operation buttons 12 (steps S221 and S222). Correction is performed once more using the correction level selected by the user, and the post-correction image is displayed on the display 11 (steps S218 and S219). Where ‘0’ is selected as the correction level, the uncorrected image is displayed.

As described above, in the cellular phone 1, the correction level may be selected through an operation by the user.

On the other hand, where the user determines that the corrected image is appropriate and the correction level is confirmed via the operation of the operation buttons 12, the correction level selected by the correction level selector 205 is stored in the RAM 33 as correction data 223 (step S223). That is, the correction level selector 205 is shown in FIG. 16 as a component that performs both selection of a correction level and generation of correction data.

The image data 221, the corrected image data 222 and the correction data 223 stored in the RAM 33 are extracted by the data forwarder 202, which received a command via the operation buttons 12, and are stored in the external memory 113 or sent to another terminal via the transmitter 115 and the antenna 15 (see FIG. 2).

As described above, in the cellular phone 1, correction data 223 that indicates the nature of the correction is separately stored. Therefore, when communication is carried out using such a cellular phone 1, various images that can be obtained using the correction data 223 can be observed.

For example, where image data 221 and correction data 223 are sent from one cellular phone 1, the receiving cellular phone 1 performs warp correction to the image data 221 via the warp corrector 201 using the correction level indicated by the correction data 223, and the post-correction image is displayed on the display 11. Consequently, the image that has undergone the sender's preferred warp correction is automatically displayed to the recipient. Because the receiving cellular phone 1 has the pre-correction image data 221, an image corrected using a different correction level or no correction may also be displayed.

Where corrected image data 222 and correction data 223 are sent from one cellular phone 1, warp correction is not performed on the side of the receiving cellular phone 1, and the corrected image is displayed on the display 11. Here, because the nature of the correction performed can be traced from the correction data 223, the image data prior to the correction may be generated by the warp corrector 201 through reverse arithmetic processing of the warp correction. Furthermore, image data with a different correction level may also be generated.

By using the correction data 223 in this way, the degree of correction may be changed freely by the recipient.

In addition, because image data 221 and corrected image data 222 may be converted from one to the other using correction data 223, where correction data 223 exists, either the image data 221 or corrected image data 222 need not be saved. Therefore, when saving the image in the external memory 113, it is acceptable if only image data 221 and correction data 223 are saved therein. In this case, when the image is read out from the external memory 113 for display, the warp corrector 201 corrects the image data 221, which has been thus read out, using the correction level indicated by the correction data 223 to generate corrected image data 222, and the corrected image is displayed on the display 11. Consequently, it becomes unnecessary to save the corrected image data 222 in the external memory 113, and moreover, the image read out from the external memory 113 may be corrected using various different correction levels.

Naturally, only corrected image data 222 and correction data 223 can be saved in the external memory 113, and in this case, pre-correction image data may be generated by the warp corrector 201 through reverse arithmetic processing of the warp correction using the corrected image data 222 and the correction data 223 read out from the external memory 113.

As described above, in the cellular phone 1 of the third embodiment, because the need for correction is automatically determined depending on the size of the image of the main object, and moreover the degree of correction is automatically changed accordingly, an image that has undergone appropriate correction can be obtained without the performance of any special operation on the part of the user.

Moreover, where the user finds the correction not desirable, the degree of correction can be changed, and moreover, the degree of correction can also be changed by the recipient through the sending of correction data 223.

In addition, the size of the image of the main object may be extracted from the area of the main object image to determine the correction level.

<Fourth Embodiment>

A correction level is selected in accordance with the size of the main object image in the third embodiment, but it is also possible to perform this selection based on the distance between the main object and the cellular phone 1, because as described with reference to FIG. 5, the warp of the main object image becomes increasingly conspicuous as the distance between the main object 9 and the imaging portion 2 decreases.

The cellular phone 1 comprising a fourth embodiment that selects a correction level based on the distance to the main object is described below. This cellular phone 1 has the construction shown in FIGS. 1 and 2, to which a sensor for distance measuring is added, and in the description below the same numerals are used for the same components described in regard to the third embodiment.

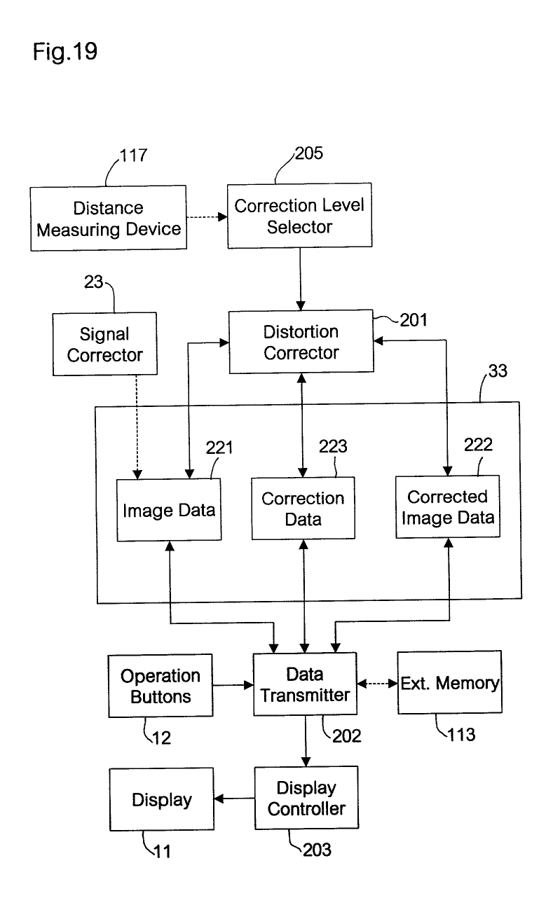

FIG. 19 is a block diagram showing the construction of the functions of the cellular phone 1 of the fourth embodiment that are realized by the CPU 31 when it operates in accordance with the program 321 stored in the ROM 32, as well as other components. It is identical to that shown in FIG. 16, except that the size detector 204 is replaced with a distance measurement device 117.

The distance measurement unit 117 has a sensor, and measures the distance between the main object and the imaging portion 2 using the phase difference detection method, for example. The distance measured is input to the correction level selector 205, which selects a correction level.

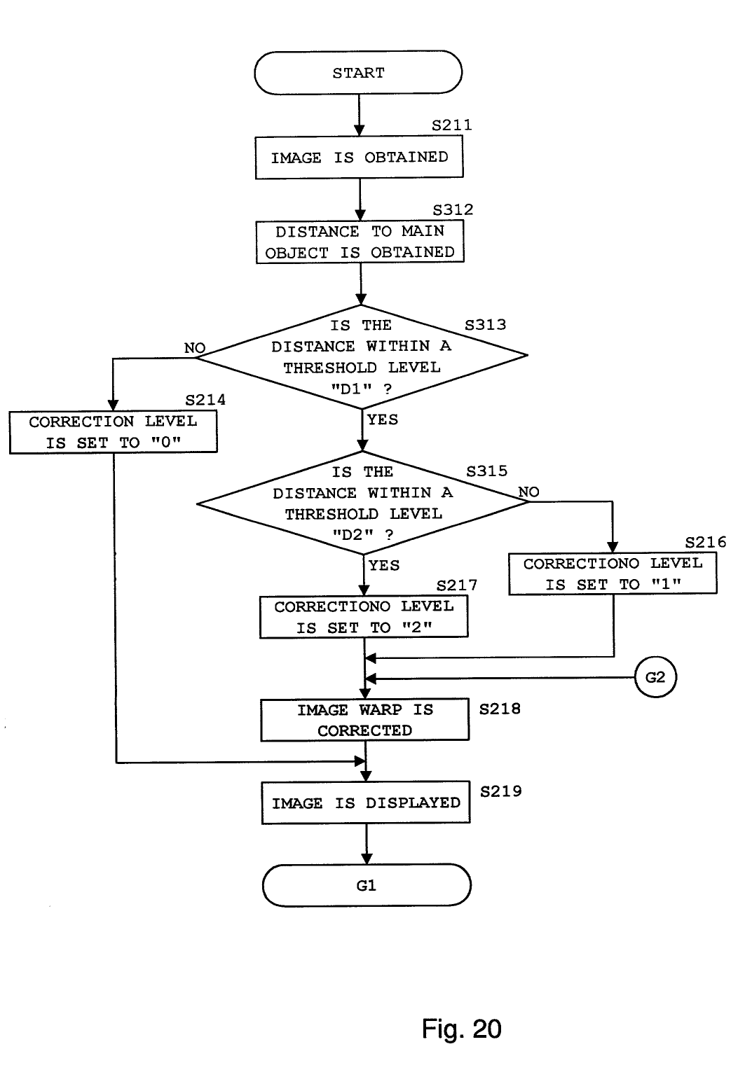

FIG. 20 is a drawing showing part of the sequence of operations carried out by the cellular phone 1 of the fourth embodiment. The remaining part of the routine is the same as in FIG. 18. The same numbers are used in FIG. 20 for operations that are identical to those executed in FIG. 17. The operations carried out by the cellular phone 1 when it obtains an image are described below with reference to FIGS. 18, 19 and 20.

First, when image capture is instructed via the operation of the operation buttons 12 and an image is obtained (step S211), the distance to the main object is also obtained by the distance measurement unit 117 essentially simultaneously with the above operation (step S312).

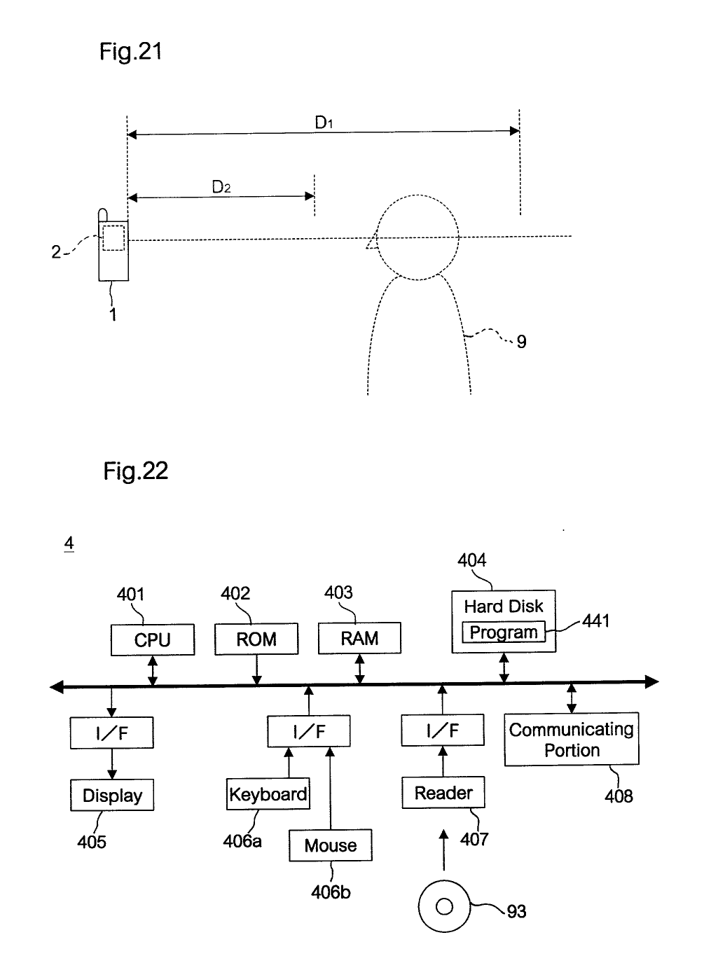

The distance to the main object thus measured is input to the correction level selector 205, which selects a correction level. Selection of a correction level is performed by comparing the threshold values D1 and D2, which are predetermined distances, with the distance from the cellular phone 1 to the main object 9, as shown in FIG. 21. In other words, where the distance to the main object equals or exceeds the threshold value D1, it is determined that the main object and the imaging portion 2 are located a sufficient distance apart and that as a result no correction is needed, and the correction level is set to ‘0’ (steps S313 and S214). Where the distance to the main object is less than the threshold value D1 but equals or exceeds the threshold value D2, which is smaller than the threshold value D1, it is determined that a low degree of correction is needed, and the correction level is set to ‘1’ (steps S315 and S216). Where the distance to the main object is less than the threshold value D2, it is determined that a high degree of correction is needed, and the correction level is set to ‘2’ (steps S315 and S217).

Subsequently, as in the third embodiment, where correction is needed, the warp corrector 201 corrects the warp of the image data 221 based on the correction level selected by the correction level selector 205, and generates corrected image data 222 (step S218). As described above, the cellular phone 1 determines whether or not correction is needed by comparing with the threshold value Dl the distance to the main object that is detected in essence via the distance measurement unit 117, and selects a correction level 1 or 2 by comparing the object distance with the threshold value D2.

When the corrected image data 222 is stored in the RAM 33, the image is displayed in the same way as in the third embodiment (step S219), and the correction level is changed by the user where necessary (FIG. 18).

In addition, storing the correction level in the RAM 33 as correction data 223 and sending it to the recipient allows the degree of correction to also be changed on the side of the recipient.

As described above, in the cellular phone 1 of the fourth embodiment, it is automatically determined whether or not correction is needed and the degree of correction is automatically changed based on the distance to the main object, and therefore an image that has undergone appropriate correction can be obtained without the user performing any special operation.

<Fifth Embodiment>

While the processing of the image data takes place inside the cellular phone in the embodiments described above, such processing may alternatively be performed by a separate image processing apparatus.

FIG. 22 is a block diagram showing the construction of an image processing apparatus 4. The image processing apparatus 4 has the general computer system construction in which a CPU 401 that performs various types of arithmetic processing, a ROM 402 that stores the basic program, and a RAM 403 that stores various types of information are connected to a bus line. Also connected to the bus line via an interface (I/F) where appropriate are a hard disk drive 404 that stores data and the like on a hard disk, a display 405 that displays information and images, a keyboard 406a and mouse 406b that receive input from the operator, a reading device 407 that reads out information from a recording medium 93 such as an optical disk, magnetic disk or magneto-optic disk, and a communicator 408 that performs communication with other communication devices via a communication network.

In the image processing apparatus 4, a program is read out in advance from the recording medium 93 via the reading device 407 and stored on the hard disk via the hard disk drive 404. The program 441 is copied to the RAM 403, and the image processing apparatus 4 performs warp correction to the image when the CPU 401 executes arithmetic processing in accordance with the program stored in the RAM 403.

In other words, the CPU 401 mainly executes the functions of the warp corrector 201, the data forwarder 202 and the display controller 203 shown in FIG. 6, the keyboard 406a and the mouse 406b execute the same functions as the operation buttons 12, and the display 405 executes the same functions as the display 11 of the cellular phone 1.

Image data captured by a cellular phone or small digital camera is stored in advance in the hard disk of the image processing apparatus 4 in a state ready for processing. For example, image data is read onto the hard disk from the external memory of a cellular phone or digital camera, or received from a cellular phone via the communicator 408 or as an attached file to an e-mail, and is stored on the hard disk by the hard disk drive 404.

When the image data is ready, the CPU 401 executes the same warp correction as in the first embodiment, whereupon the peripheral areas of the image are enlarged and the post-correction image is displayed on the display 405 (equivalent to steps S13 and S14 of FIG. 7).

Naturally, in the image processing apparatus 4, a correction level may be selected by the user from among multiple correction level options as in the third or fourth embodiment, enabling more appropriate correction to be realized.

Furthermore, image data 221 and correction data 223 or corrected image data 222 and correction data 223 may be forwarded by the cellular phone 1 of the third or fourth embodiment to the image processing apparatus 4. Through such forwarding, a corrected image intended by the sender may be displayed on the display 405, and an image with a different degree of correction and the pre-correction image may also be displayed on the display 405.

<Sixth Embodiment>

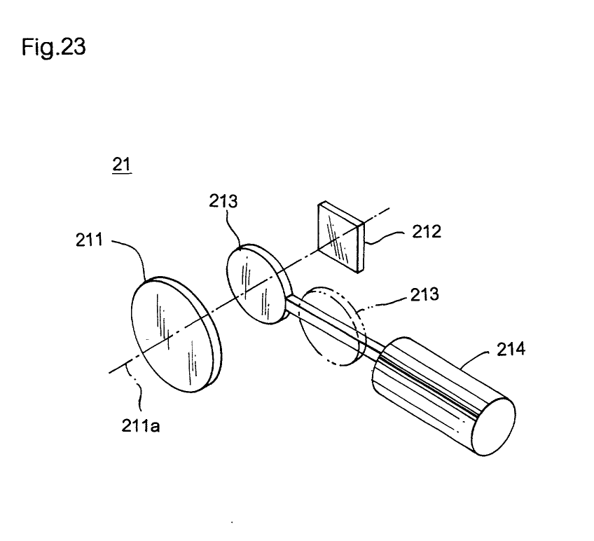

In the first through fourth embodiments, warp in which the perspective is exaggerated is corrected by processing the output from the solid imaging element after converting it into digital signals, but such correction may also be performed optically. FIG. 23 is a perspective view showing the construction of the optical unit 21 when correction is carried out using a correction lens unit 213.

The correction lens unit 213 is located between the lens unit 211 and the CCD 212, and can be extended into and retracted from the optical axis 211a of the lens unit 211 by an electromagnetic plunger 214. The correction lens unit 213 is designed such that it enlarges the peripheral areas of the image relative to the image center area using the characteristic shown in FIG. 8.

When obtaining a corrected image, the correction lens unit 213 extends into the optical axis 211a, and where no correction is to be performed, it is retracted to a position outside the optical axis 211a. Consequently, both the image of a close-up main object such as a person's face and distant images such as landscape may be appropriately captured. In addition, because it is not necessary to perform image processing, the time required for processing of the image data can also be reduced.

The technology to correct using a correction lens unit 213 the warp in which the perspective is exaggerated may be applied in a camera that obtains an image using silver halide film. In addition, the correction lens unit 213 may be moved via user operation of a lever or the like.

<Modification>

Although the descriptions above pertain to embodiments of the present invention, the present invention is not limited to such descriptions, and may be modified in various ways.

For example, in the above embodiments, the peripheral areas of the image are enlarged relative to the center area. This is done because it is assumed that the main object has an essentially convex configuration that protrudes towards the imaging portion 2. Depending on the configuration of the main object, the characteristic of the image warp that occurs due to the three-dimensional configuration of the main object when the main object and the imaging portion 2 are close together varies. Therefore, if the three-dimensional configuration of the main object is known, warp correction that is tailored to the configuration of the main object may be performed.

Specifically, when capturing the image of a main object that has a cylindrical configuration extending in the vertical direction, warp correction having the characteristic shown in FIG. 8 is performed with regard to the side peripheral areas only, and where it is known in advance that part of the surface of the main object is a flat surface directly facing the imaging portion 2, warp correction is not performed regarding this flat surface.

In addition, in the above embodiments, the peripheral areas of the image are enlarged relative to the center area, but it is also possible for the center area to be reduced relative to the peripheral areas. In other words, the peripheral areas of the image are enlarged in relation to the center area. This also applies when the correction lens unit 213 in the sixth embodiment is used.

In the third and fourth embodiments, three correction level options are available, but the number of options is not limited to three; it may be two (including the switching between correction and no correction) or four or more. Using multiple correction levels, more appropriate warp correction may be obtained based on the various sizes of the main object image and the various distances to the main object.

In the third and fourth embodiments, the selected correction level is stored as correction data 223 in the RAM 33 or the external memory 113, but the correction data 223 may comprise another type of data so long as it indicates the contents of the correction. For example, the relationship between the enlargement rate and the distance from the image center, which is shown in FIGS. 14 or 15, may be stored as correction data 223, or the scope of the sections 811 through 814 and the enlargement rate for each section shown in FIGS. 11 and 12 may be stored as correction data 223. If this is done, when the cellular phone 1 of the third or fourth embodiment or the image processing apparatus of the fifth embodiment receives image data 221 and correction data 223, warp correction of the image may be performed without being bound by a pre-determined correction characteristic.

It was explained with regard to the third and fourth embodiments that the correction data 223 is stored in the RAM 33 after it is generated, but it may alternatively be sent to the terminal of the other party to the communication without being stored. That is, image data 221 and correction data 223 may be output to an external device without being stored in the cellular phone 1.

Moreover, in the third and fourth embodiments, the degree of correction may be made variable based on the preference of the user. For example, an image that exhibits reverse warp (warp in which the peripheral areas of the main object appear to be closer to the observer) can be created by performing stronger correction.

In the above embodiments, the function of the warp corrector 201 was realized by the CPU operating in accordance with a program, but part or whole of the function may be realized via a dedicated electric circuit.

The program 321 in the cellular phone 1 of the first through fourth embodiments may be written to the rewritable ROM 32 from an external memory 113, which comprises a recording medium, or via the receiver 114. This enables warp correction capability to be added after the purchase of the cellular phone 1.

In accordance with each construction described above, the image warp caused by the close proximity between the main object and the image sensor can be corrected.

In addition, using the constructions described above, the following benefits are further obtained.

Where the main object essentially protrudes toward the image sensor, the image warp can be appropriately corrected.

The correction process can be simplified.

Whether or not to perform correction can be made selectable.

It can be automatically determined whether or not correction is needed.

The appropriate correction level can be selected for more appropriate correction. In addition, a correction level can be selected based on the user's preference, or a correction level can be automatically selected.

The user can easily recognize that correction was performed.

Correction data can be generated, and correction of the image warp can be carried out using the correction data.

A corrected image can be obtained via a correction lens unit and without performing image processing.

Correction can be carried out in accordance with the correction data received from an external device.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A digital photographing apparatus comprising:
an image sensor that obtains the image of the object; and
an image corrector that corrects image warp caused by the three-dimensional configuration of the main object due to the close proximity between the main object and the image sensor.

2. The digital photographing apparatus according to claim 1, wherein said image corrector corrects image warp caused by the three-dimensional configuration of the main object due to the fact that the image of the main object occupies a large percentage of the overall image, as well as due to the close proximity between the main object and the image sensor.

3. The digital photographing apparatus according to claim 1, wherein said image corrector enlarges the peripheral areas of the image relative to the center area.

4. The digital photographing apparatus according to claim 1, wherein said image corrector divides the image into multiple sections and enlarges the multiple sections using an enlargement rate corresponding to each section.

5. The digital photographing apparatus according to claim 1, further comprising a receiving device that receives from the operator a command to initiate correction by the image corrector.

6. The digital photographing apparatus according to claim 1, further comprising a detector that detects the size of the image of the main object relative to the overall image and determines based on this size whether or not correction by the image corrector is needed.

7. The digital photographing apparatus according to claim 1, further comprising (i) a distance measuring device that measures the distance from the image sensor to the main object, and (ii) a detector that determines based on this distance whether or not correction by the image corrector is needed.

8. The digital photographing apparatus according to claim 1, wherein said image corrector performs correction in accordance with the correction level selected from among multiple correction levels, each representing a degree of correction.

9. The digital photographing apparatus according to claim 8, further comprising a receiving device that receives the operator's selection of a correction level from among the multiple correction levels.

10. The digital photographing apparatus according to claim 8, further comprising (i) a detector that detects the size of the image of the main object relative to the overall image, and (ii) a selector that selects a correction level based on this size.

11. The digital photographing apparatus according to claim 8, further comprising (i) a distance measuring device that measures the distance from the image sensor to the main object, and (ii) a selector that selects a correction level based on this distance.

12. The digital photographing apparatus according to claim 1, further comprising a display that indicates that correction was performed by the image corrector.

13. The digital photographing apparatus according to claim 1, further comprising a data generator that generates correction data that indicates the contents of the correction carried out by the image corrector.

14. The digital photographing apparatus according to claim 13, further comprising a memory that stores the correction data together with the image data or corrected image data.

15. The digital photographing apparatus according to claim 14, wherein said image corrector performs correction to the image data stored in the memory base d on the correction data.

16. A photographing apparatus comprising:
a photo-taking device that obtains the image of the main object;
a correction lens that corrects image warp caused by the three-dimensional configuration of the main object due to the close proximity between the main object and the image sensor; and
a lens driver that extends or retracts the correction lens toward or away from the optical axis of the image sensor.

17. A computer program that causes a computer to execute image processing, wherein said image processing comprises:
a step of preparing image data; and
a step of correcting, by processing the image data, image warp caused by the three-dimensional configuration of the main object due to the close proximity between the main object and the image sensor during image capture.

18. An image processor comprising:
a memory that stores image data; and
an image corrector that corrects, by processing the image data, image warp caused by the three-dimensional configuration of the main object due to the close proximity between the main object and the image sensor during image capture.

19. The image processor according to claim 18, further comprising a receiver that receives from an external device image data and correction data that indicates the contents of correction, wherein said image corrector performs correction based on the correction data.
